(19) United States
(12) Patent Application Publication
(10) Pub. No.: US 2003/0161008 A1
(43) Pub. Date: Aug. 28, 2003

(54) Method to record event

(76) Inventor: Trey ZehrGrimm, River Falls, WI (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/374,145

(22) Filed: Feb. 25, 2003

Related U.S. Application Data
(60) Provisional application No. 60/359,589, filed on Feb. 26, 2002.

(51) Int. Cl. H04N 1/21; H04N 1/23

(52) U.S. Cl. 358/3.29; 358/296

(57) ABSTRACT

The method in general enables an individual to verify personal attendance at an event and to simultaneously record an event for permanent transfer onto a souvenir acquired at the event. In general, the method will transfer the image of an individual's ticket and/or ticket stub along with personalized information which may further include an event summary onto a souvenir available for purchase at the event.

### CROSS REFERENCE TO RELATED APPLICATIONS

This application is based upon and claims priority to U.S. Provisional Patent Application Serial No. 60/359,589, filed Feb. 26, 2002, the entire contents of which are incorporated by reference herein in its entirety.

### BACKGROUND OF THE INVENTION

In the past, souvenirs have been available at events such as races, sporting contests, and/or concerts. In general, the types of souvenirs available at these types of events include T-shirts, coffee mugs, sports memorabilia, and/or other souvenir items. Event programs for the specific event are also frequently available for acquisition by an individual.

Each year, a large number of souvenirs commemorating specific events are sold. Generally, the souvenirs display the name and the date of the event along with appropriate names, logos, and/or trademarks of the event participant's. Such souvenirs are popular, in part, because the souvenirs allow the wearer to show knowledge of and/or support for an event participant of the individuals choosing. These souvenirs do not suggest that the owner/displayer attended this event, nor do the souvenirs provide detailed information available only following completion of the event.

In the past it has not been known to verify an individuals attendance at an event such as a concert, race, and/or sporting contest by creating a personalized souvenir for an individual. Also, it has not been known to permit an individual to personalize the recording of attendance at an event by submission of desired types of information for transfer onto a souvenir.

Also, in the past, it has not been known to provide souvenirs to individuals through the on site use of permanent marking devices for use on T-shirts and other souvenirs as customized at the time and location for the event. It has also not been known to allow individuals to personally select information or event information to be recorded on a souvenir upon the attendance of an event which in turn functions as a personalized record for attendance of an event. A need therefore exists for a method to enable an individual to personalize the recording of an event and further to personally record individual attendance of an event.

### SUMMARY OF THE INVENTION

The method in general enables an individual to verify personal attendance at an event and to simultaneously record an event for permanent transfer onto a souvenir acquired at the event. In general, the method will transfer the image of an individual's ticket and/or ticket stub along with personalized information or event specific data which may further include an event summary, or other information onto a souvenir available for purchase at the event.

An advantage of the method is to personalize an event summary for a specific event for recording of individually selected personal or event specific information upon a souvenir.

Another advantage of the method is to enlarge, and/or record, an admission ticket and/or ticket stub on a souvenir to verify attendance at an event.

Still another advantage of the method is to permit an individual to select from a variety of different types of souvenirs for use to memorialize attendance at an event where the souvenirs would include the recordation of personally selected information.

Still another advantage of the method is to use modern digital image recording equipment to record information and/or images about an event for transfer onto a souvenir.

Still another advantage of the method is to provide transportable electronic recording and storage equipment which may be utilized at an event, or accessed after an event, to retrieve previously stored data.

Still another advantage of the method is to provide a printer in communication with the electronic recording and storage equipment and/or media for transfer of individual specific pre-stored images or post event data or information onto a souvenir.

Still another advantage of the method is to print or provide customized and/or individualized information at any location relative to a souvenir as desired by an individual.

### BRIEF DESCRIPTION OF THE DRAWINGS

FIG. 1. is front view of a souvenir t-shirt created according to the inventive method described herein.

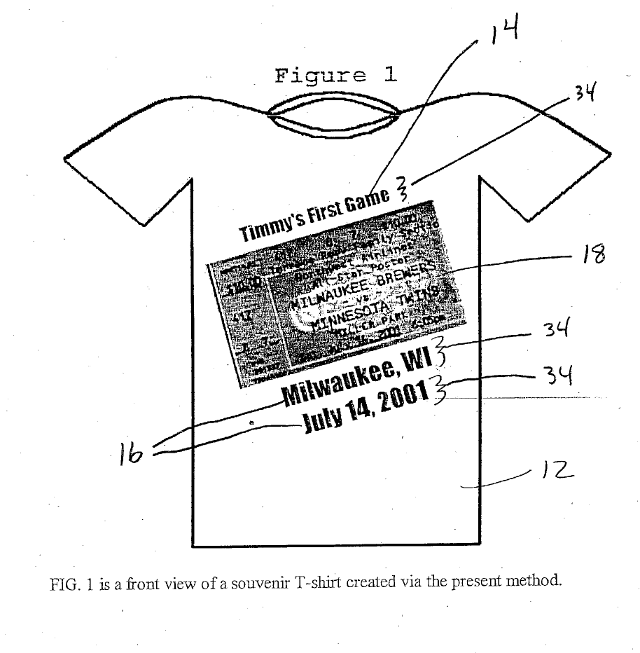

FIG. 2. is a reverse side of a souvenir t-shirt created according to the inventive method described herein.

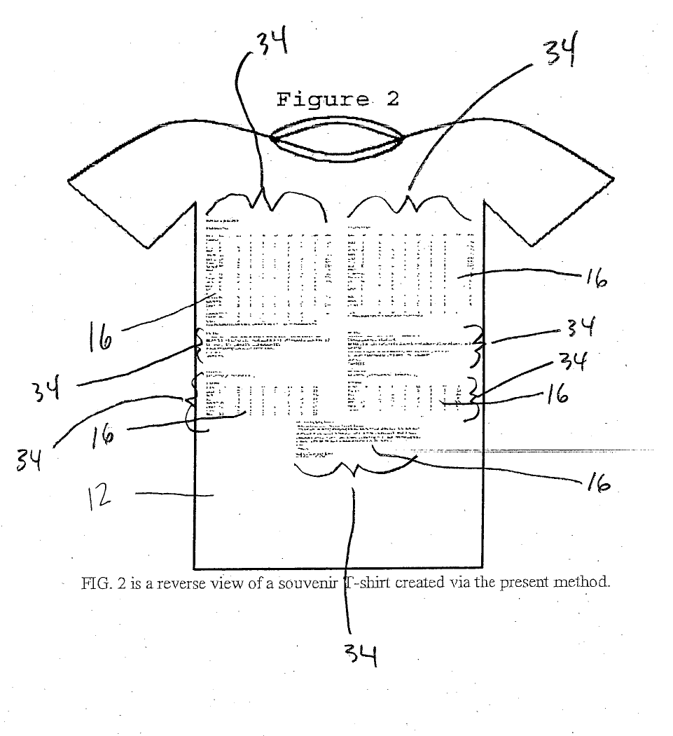

FIG. 3. is a block diagram of the inventive method described herein.

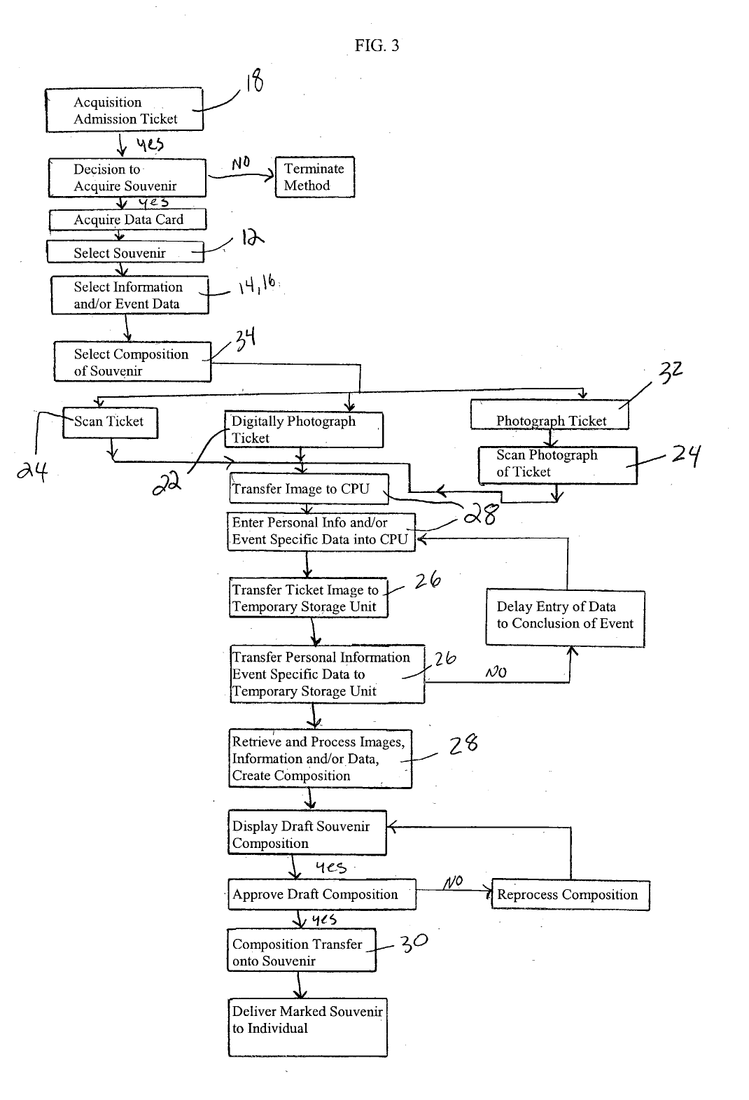

### DETAILED DESCRIPTION OF THE PREFERRED EMBODIMENT

The method includes the photographic, digital, or pictorial recording and display of images of an individuals attendance of an event as memorialized in a personalized event summary 10 for transfer onto a souvenir 12. The method for recording of a personalized event summary 10 enables an individual to own displayable proof of presence and attendance of an event along with data pertaining to the event. The displayable proof of presence and attendance of an event will normally be in the form of a souvenir 12 which may be worn, utilized, or may be suitable for framing and/or any other desired manner of display. The types of events may include, but are not necessarily limited to, concerts, races, and/or sporting contests.

The personalized event summary 10 of the specific event may include a category of personalized information 14 such as “Johnny's First Game” and/or other information as desired by an individual. In addition, the personalized event summary 10 may include information such as the identities of individuals in attendance at an event such as families, friends, and/or groups of individuals. For example, a group of friends, fraternity, sorority, or significant other may be identified as being in attendance at an event in conjunction with the designated individual. Each individual within a group would also have the opportunity to re-organize information within the personalized event category 14 for creation of a specific individualized event souvenir 12. The personalized information 14 may be represented by words, text, images, pictures, logos, and/or any other information or combination of words, pictures, logos, text, images, and/or any other information as identified herein for creation of a customized and/or personalized event summary 10.

Each member of a group may also customize the information contained within a category of event specific information or data 16 available during, or at the conclusion of the event, so that each member of the group in attendance may acquire a unique personalized event souvenir 12.

The method for recording of a personalized event summary 10 is for a process in which a souvenir 12 of a particular event is created with a display of proof of admission to the event, which is normally a recorded image of a ticket or ticket stub 18. The proof of admission to the event may be memorialized by the use of digital 22, photographic 32, or scanning 24 equipment in conjunction with processing 28 and printing 30 equipment for the recording and transfer of the proof of admission upon a souvenir 12. Personalized information 14 and/or event specific data 16 may be recorded upon temporary storage media 26 for retrieval, processing and transfer for printing 30, attachment to, or placement upon a souvenir 12.

The event specific data 16 may include blanks or fields 34 which may be completed during or following the conclusion of the event. An individual may customize the information to be recorded within one or more fields 34 for transfer initially to the temporary storage media 26 for processing within the central processing unit (CPU) 28 and for ultimate transfer onto a souvenir 12. Software as stored within the CPU 28 preferably regulates entry of information within one or more fields such as personalized information 14, event specific data 16 and/or proof of admission 18. Software as stored within the CPU 28 also preferably regulates the transfer of information and/or data to the temporary storage media 26. Information and/or data may be transferred to the temporary storage media 26 during or at the conclusion of, the event. The CPU 28 may include multimedia and/or graphic functions, capabilities, and/or software. The CPU 28 preferably enables an individual to select from a variety of options related to features such as enlargement of text or images; font styles and/or sizes; color options; location and placement of text and/or images; and updating and/or reorganization functions.

The temporary storage media 26 is preferably integral to the CPU 28. Alternatively, the temporary storage media 26 may be connected to the CPU 28 by any suitable communication cable.

Event specific data 16 may include but is not necessarily limited to participant statistics, event occurrences, event statistics, the length of the event, or the outcome off the event. The event specific data 16 may include but is not necessarily limited to words, text, images, pictures, logos, and/or any other information or combination of material as identified herein. For example, event specific data 16 may include text and a photographic image of a player hitting a record breaking homerun or scoring a goal. Alternatively, the event specific data 16 may include a list of songs as played in a particular order at a concert, statistics of an event, the results of an event, an image of a photo finish of an automobile race or any other image or information as desired.

The event specific data 16, personalized information 14, and/or the proof of admission 18 is generally recorded onto the souvenir 12 by the souvenir manufacturer or by a souvenir purchaser at the time of the purchase of the souvenir 12. The method 10 permits the attendees of an event to individually display proof of admission and attendance of an event in conjunction with customized and/or standardized data pertaining to the event.

The method to record an event 10 initiates upon the acquisition of an admission ticket 18 for the event. The ticket 18 may be obtained through any conventional means such as through the global telecommunications network, use of the telephone, and/or purchase at a ticket window. At the time of purchase of the admission ticket 18 an individual may indicate a desire to initiate the souvenir marking process and method to record the event 10. Alternatively, an individual may attend the event and elect to use the ticket and/or ticket stub 18 for recording upon a souvenir 12 at the location of the event.

The next step in the method to record an event 10 involves the attendance 20 of an individual at an event individually, with family, and/or with friends.

The next step for the method to record an event 10 involves the decision to acquire a souvenir 12. At this step, an attendee may acquire a data card to provide information such as a name, address, telephone number, delivery options, organizational preferences for the souvenir 12, personal information 14 to be included on the souvenir 12, as well as the types, if any, of information to be entered into an event specific data 16 category and/or the relative positioning of the categories of information upon the souvenir 12. An individual will normally make the indicated selections by examination of sample alternatives displayed proximate to an order placement location. At the time of placement of an order an assistant may enter information into a keyboard in communication with the CPU 28. A monitor in communication with the CPU 28 may then display a draft of the images, markings, text, and/or available information, and the relative location of information to be placed upon a souvenir 12. The attendee may then approve of the draft or reorganize the draft at the individuals discretion. This process may transpire at the conclusion of the event, during the event, or prior to the initiation of the event.

The next step for the method to record an event 10 involves the selection of a souvenir 12. An individual may select a souvenir 12 from groups of items consisting of T-shirts, sweatshirts, hats, sports equipment, coffee mugs, and/or any other item which may be sold as a souvenir 12 which further is receptive to marking, image transfer, and/or printing of indicia.

The next step within the method to record an event 10 utilizes digital or photographic recording 22 and/or scanning equipment 24. The digital or photographic equipment 22 and/or scanning equipment 24 may record an image of an admission ticket and/or ticket stub 18, in addition to personal information 14, for transfer into the temporary storage media 26. The ticket stub and/or ticket 18 may be photographed and/or digitally recorded 22 and/or scanned 24 for storage as a file on a CPU 28 hard drive and/or floppy disc. Alternatively, the ticket stub and/or ticket 18 may be recorded within any other type of electronic storage media 26 or otherwise. Equipment necessary to digitally or photographically record 22 and/or scan 24 personalized information 14 may include a digital camera 22, scanner 24, CPU processing unit 28, and/or a temporary storage device 26 in communication with the camera 22 and/or scanner 24. The temporary storage unit 26 is preferably used to retain recorded images for printing upon selected souvenirs 12 proximate to the time of conclusion of an event.

The method to record an event 10 next involves entering event specific data 16 such as an event summary into the temporary storage unit 26. Event data 16 may include, but is not necessarily limited to, the date of the event, the time of the event, the location of the event, the score of the event, the attendance at the event, the event history, and/or event summary. Another example of event data 16 may be information which an individual perceives as important to assist in the recollection of the event such as “Diving Highlight Film Catch By My Favorite Player”. Alternatively, event data 16 may include preprinted information such as score cards and/or recording cards which may be used for recording information by an individual during the course of the event. At any time during, and/or at the end of an event, an individual may record information to be scanned 24 and/or recorded into the temporary storage media 26.

At the end of the event, the temporary storage media 26 is accessed to retrieve stored event data 16 and/or personalized information 14 whereupon the CPU 28 organizes and processes the personalized information 14, as well as recorded event data 16 into a composition which may include images, and/or text, and particularly an image of a ticket or ticket stub 18 for transfer to a printer 30 for printing on one or more sides of a souvenir 12. The personalized information 14, event specific data 16, and/or proof of attendance 18 may be organized in any combination and/or at any location relative to a desired souvenir. Any combination of personalized information 14, event specific data 16, and/or proof of attendance 18, may be positioned at any desired location on the front and/or back of a T-shirt or other type of souvenir 12. The combinations available for positioning of the personalized information 14, event specific data 16, and/or proof of attendance 18 are generally unlimited. In addition, an individual is not required to utilize all of the categories of personalized information 14, event specific data 16, and/or proof of attendance 18 upon a souvenir. An individual may elect one or more of the above-identified categories for placement upon a souvenir 12.

Preferably, the printer 30 is capable of printing information on clothing and other types of items as mentioned herein. The printing equipment 30 may also be sufficiently flexible for permanent printing of images and/or information directly onto the souvenir 12 or onto film or other media for transfer onto a souvenir 12. Alternatively, any number of types of printers 30 may be utilized to print information on souvenirs 12 such as coffee mugs, sporting goods items, posters, and/or any other type of items which may receive markings to memorialize an event.

The printed souvenir 12 may then be picked upon or delivered to an individual where the souvenir 12 includes the recorded personalized information 14, tickets, ticket stubs, 18 and/or event data 16 on one or more sides of the souvenir 12. The souvenir 12 is preferably washable and is marked with permanent markings which may be formed of non-bleeding colored and/or black ink.

The above examples and disclosure are intended to be illustrative and not exhaustive. These examples and description will suggest many variations and alternatives to one of ordinary skill in the art. All of these alternatives and variations are intended to be included within the scope of the attached claims. Those familiar with the art may recognize other equivalents to the specific embodiments described herein which equivalents are also intended to be encompassed by the claims attached hereto.

The present invention may be embodied in other specific forms without departing from the spirit or essential attributes thereof; therefore, the illustrative embodiments should be considered in all respects as illustrative and not restrictive, reference being made to dependent claims rather than to the foregoing description to indicate the scope of the invention.

While this invention may be embodied in many different forms, there are described in detail herein specific preferred embodiments of the invention. This description is an exemplification of the principles of the invention and is not intended to limit the invention to the particular embodiments illustrated.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below (e.g. claim 3 may be taken as alternatively dependent from claim 2; claim 4 may be taken as alternatively dependent on claim 2, or on claim 3; claim 6 may be taken as alternatively dependent from claim 5; etc.).

This completes the description of the preferred and alternate embodiments of the invention. Those skilled in the art may recognize other equivalents to the specific embodiment described herein which equivalents are intended to be encompassed by the claims attached hereto.

I claim:

1. A method to record an event comprising:
a. acquisition of an admission ticket to an event;
b. selection of a souvenir to memorialize the event;
c. recording an image of at least a portion of the admission ticket;
d. temporarily storing the recorded image within a temporary storage unit;
e. retrieving the recorded image from the temporary storage unit for transfer to an image transfer device;
f. transferring the recorded image onto said souvenir; and
g. delivering the souvenir to an individual.

2. The method according to claim 1 further comprising the step of attending the event.

3. The method according to claim 1, said recording an image comprising digital recording of said image.

4. The method according to claim 1, said admission ticket comprising a ticket stub.

5. The method according to claim 1, said recording an image comprising scanning of said image.

6. The method according to claim 1, said recording said image comprising digitally photographing said image.

7. The method according to claim 1, said recording an image comprising photographing said image.

8. The method according to claim 1, further comprising entry of personal information into said temporary storage unit.

9. The method according to claim 8, further comprising retrieving the recorded image and retrieving the personal information for transfer of said recorded image and said personal information to a central processing unit for processing prior to said step of transferring onto the souvenir.

10. The method according to claim 9, further comprising entry of event specific data into said temporary storage unit.

11. The method according to claim 10, further comprising retrieving the recorded image, retrieving the personal information, and retrieving the event specific data for transfer of said recorded image, said personal information, and said event specific data to a central processing unit for processing prior to said step of transfer onto said souvenir.

12. The method according to claim 11, said processing comprising assignment of said event specific data into at least one field prior to said step of transfer onto said souvenir.

13. The method according to claim 1, said transfer of said recorded image onto said souvenir comprising printing.
